(19) United States
(12) Patent Application Publication
(10) Pub. No.: US 2004/0254655 A1
(43) Pub. Date: Dec. 16, 2004

(54) Dynamic parameter tuning

(76) Inventor: Man-Ho Lee, Milpitas, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/461,823

(22) Filed: Jun. 13, 2003

(51) Int. Cl. G06E 1/00; G06E 3/00; G06G 7/00; G05B 13/02; G06F 15/18

(52) U.S. Cl. 700/37

(57) ABSTRACT

Various systems and methods permit a parameter associated with a system to be dynamically tuned to an optimal value. For instance, a method of operating the system with the parameter set at a current value, determining a performance of the system with the parameter at the current value, determining a performance of the system with the parameter at a second value, and comparing the performances.

### BACKGROUND

In general, some systems operate based on one or more parameters that may be set or programmed into the system. By way of example, and without limitation, a computer system may comprise multiple computer nodes coupled together thereby permitting messages to be passed back and forth between nodes. Each node may comprise an output buffer into which messages may be posted pending their transmission to one or more destination nodes. The size of that output buffer may be a parameter that is configurable. The subject matter described herein may relate to methods and system for determining such parameters.

### BRIEF SUMMARY

Systems and methods are described herein that permits a parameter associated with a system to be dynamically tuned to an optimal value. For instance, a method is disclosed that includes operating the system with the parameter set at a current value, determining a performance of the system with the parameter at the current value, determining a performance of the system with the parameter at a second value, and comparing the performances. The method changes the parameter to the second value if the performance of the system at the second value is greater than the performance of the system at the current value by a predetermined amount; or otherwise maintains the parameter at the current value.

### BRIEF DESCRIPTION OF THE DRAWINGS

For a detailed description of the embodiments of the invention, reference will now be made to the accompanying drawings in which:

FIG. 1 shows a system in accordance with embodiments of the invention;

FIG. 2 shows a method of initializing a dynamic parameter tuning process in accordance with embodiments of the invention;

FIG. 3 shows a dynamic tuning process in accordance with embodiments of the invention; and

FIG. 4 also shows a dynamic tuning process in accordance with alternative embodiments of the invention.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct connection, or through an indirect connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be exemplary of that embodiment, and not intended to intimate that the scope of the disclosure, including the claims, is limited to that embodiment.

In accordance with various embodiments, one or more parameters associated with a system may be dynamically adjusted to an optimal value. As used herein, the term “parameter” refers to an adjustable value pertaining to one or more functions performed by a system. The “optimal” value of a parameter may refer to the parameter value that results in the highest performance achievable with which a change in the value would not result in a sufficiently significant increase in performance. The processes described herein permits a system to dynamically (e.g., during run-time) tune a parameter to an optimal value. The term “tune” refers to selecting, determining, changing, or altering a parameter to achieve an optimal value.

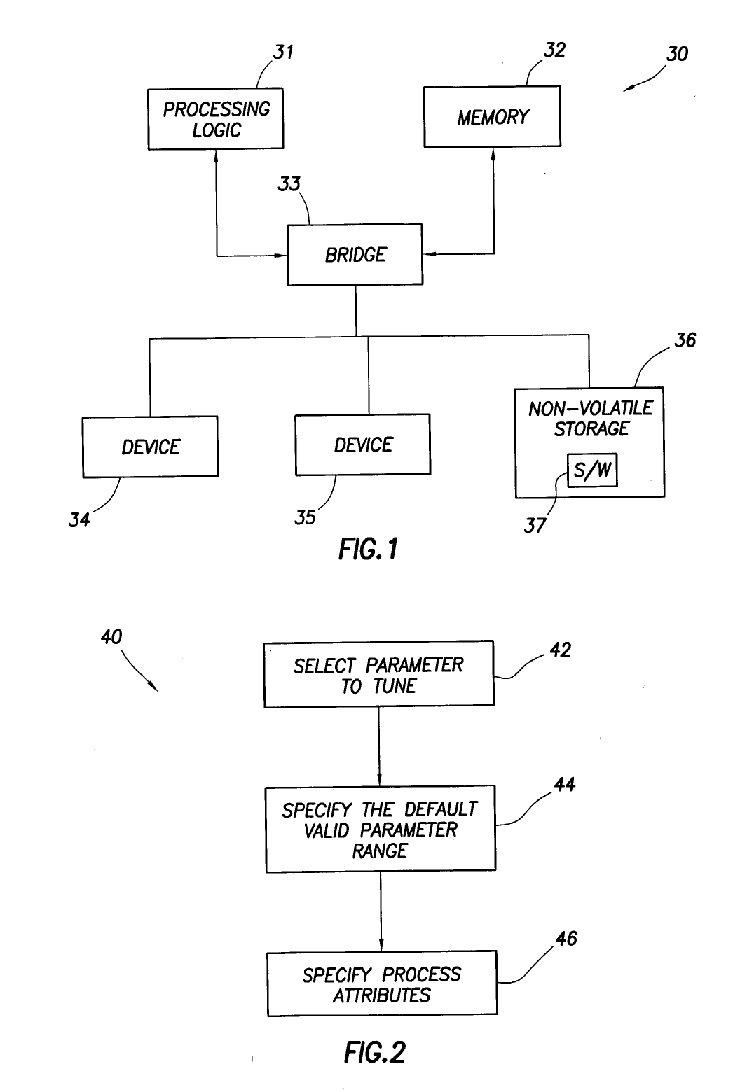

The system with which the parameter is associated includes any system that includes adjustable parameters. Without limitation, examples of such systems include computer systems (both individual computers and networks or clusters of computers), computer-related devices, consumer electronics (e.g., DVD players), and numerous other types of electrical devices. FIG. 1 shows an exemplary system 30 which uses the dynamic parameter tuning process described below. System 30 includes processing logic 31 and volatile memory coupled to a bridge 33. One or more devices 34, 35 also couple to bridge 33 along with non-volatile storage 36. Non-volatile storage 36 may comprise a read only memory (“ROM”), hard disk drive, and the like. Software 37 may be stored on non-volatile storage 37. The software 37 performs some or all of the functionality described herein.

The parameter that is tuned pursuant to the processes described herein may include any suitable parameter associated with the operation of the system. For example, one or more clusters of nodes (e.g., computers) may be coupled together via one or more switches to form a network fabric. The nodes and switches may couple together via one or more connections, which may include physical or logical connections. The nodes also may transmit packets through the fabric to other nodes. For some or all of these connections, a parameter may be dynamically tuned that specifies the number of packets that is permitted to be outstanding at any point in time for that connection. In general, this parameter may specify, or be related to, the amount of memory to be allocated for an output message buffer. The parameter may be configured to be a value of one or greater. The processes described herein finds an optimal value for such a parameter.

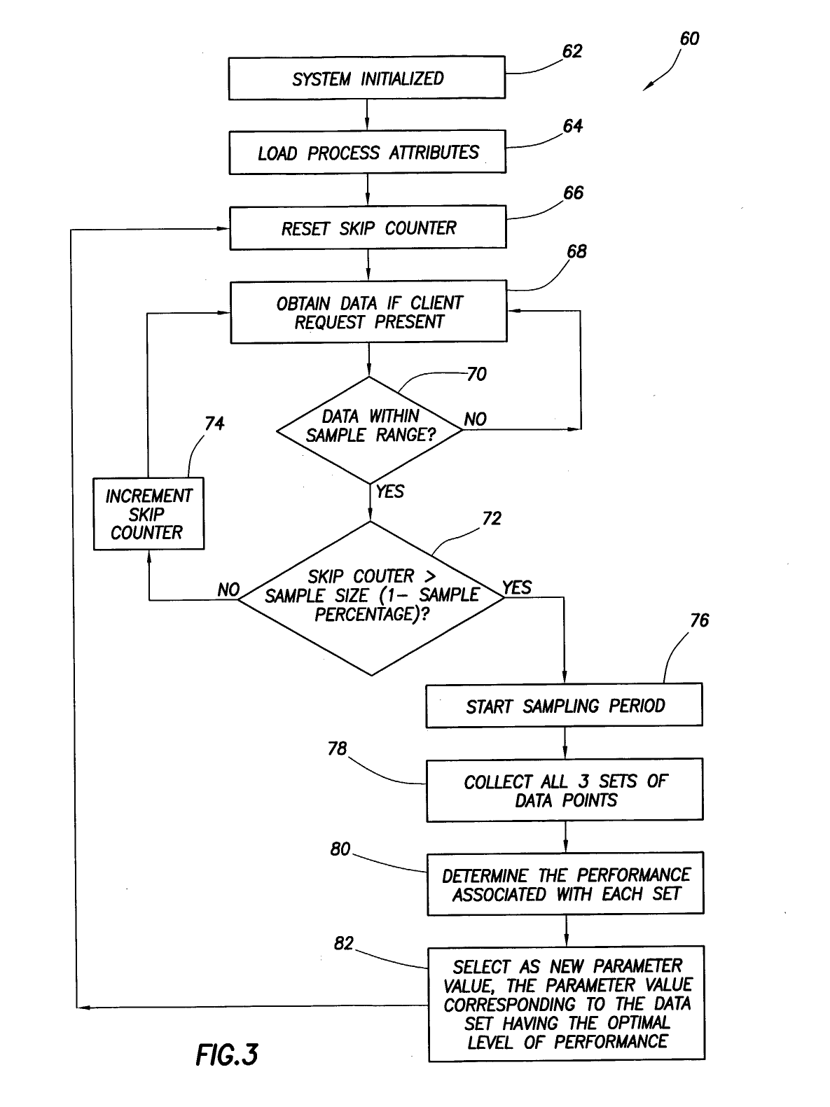

The processes may be implemented as background software routine (e.g., software 37) that runs on a processor (e.g., processing logic 31) included in the system. Typically, before the process is used, the process is configured as shown FIG. 2. Referring to FIG. 2, configuration process 40 includes blocks 42-46. In block 42, the parameter to be tuned is selected. This action may be implemented by a user of a console (not specifically shown) included within, or coupled to, the system in which the process runs. In general, one or more parameters are selected in block 42.

In block 44, a default valid range is specified for the parameter determined in block 42. The default valid range may include a range of values to which the process may be limited when tuning the parameter. For example, the default valid range for a parameter may be from 1 to 10 and, as such, the tuning process may limit the optimal value to a value from 1 to 10. As in block 42, the default valid range may be specified by a user of a console or retrieved from memory.

In block 46, a user also may specify one or more process “attributes.” The term attribute may refer to configurable values associated with the operation of the tuning process itself. The attributes may be set by a user as noted above or retrieved from non-volatile storage (e.g., a hard disk). In general, the attributes may affect the sensitivity and/or other aspects of the process. The attributes may include any or more of the following: sample size, performance significance, sampling percentage, step size, sample range, and delta. These attributes are described below. Other attributes may be included as well.

In general, the tuning process may tune a parameter based on a plurality of performance values or measurements associated with a plurality of sampled data points. The “sample size” generally specifies, or otherwise indicates, the number of data points used by the tuning process to tune the parameter. The process described herein may be “self-clocking” which means the process collects a predetermined amount of data regardless of the amount of time it may take to collect the data. Thus, the time duration of a sampling period may not be fixed. In general, a larger number of data points results in an increase in the reliability of the data being used. However, an unreasonably large sample size may cause the tuning process to react undesirably slow. This disclosure, however is not limited to any particular sample size.

The sample size may be changed while the tuning process is functioning. As will be described below, the process includes a plurality of iterations, with each iteration determining an “optimal” parameter value which may be an operational value that is statistically likely to be closer to a true optimal parameter value. Each iteration of the process thus further tunes the parameter(s). A new sample size may be implemented at the beginning of each iteration of the process. In some embodiments, sample size may be defined to be dependent on the variance of the collected data points. In general, the higher the variance of the collected data, the more data points may be desired to be collected (i.e., larger sample size).

The “performance significance” attribute is useful to help determine the optimal parameter value. Some resources (e.g., memory) in a system may be present in limited quantities. In general, it is desirable to use a system's resources as efficiently as possible. The performance significance attribute generally permits the dynamic tuning process to trade off resource usage versus performance. In some cases, for example, changing a parameter to a different value may result in better performance with regard to that parameter. However, the detriment in dedicating additional resources to support the new parameter value may outweigh the associated performance increase. Alternatively stated, in those cases in which a change in parameter value would result in relatively little performance benefit, the tuning process may opt not to change to the new parameter value and remain with the previous parameter value, albeit with inferior performance.

Percentage significance is defined as a performance threshold that represents the minimal amount of performance increase to justify a change (e.g., an increase) in the usage of resources associated with parameter value. Any performance gain obtained from using additional resources of an amount less than this threshold may be considered to be insignificant, thereby permitting the corresponding unit of resource to be allocated for another use by the system.

By way of an example, the percentage significance may be specified to be 5%. If the performance gain associated with a change in parameter value is not more than 5%, such performance gain would be determined to be insignificant. The tuning process may determine that the percentage significance threshold is not exceeded and thus not change the parameter. If, on the other hand, the determined performance associated with a new parameter value is more than 5% better than the performance associated with the current parameter value, such performance gain is considered to be significant. In this case, the process may determine that the percentage significance threshold is exceeded and cause the parameter to be dynamically changed to the new value.

The sampling percentage attribute may be specified as a percentage of total available eligible data. One sampling percentage may be specified for all parameters to be tuned, or different sampling percentages may specified for individual parameters. In general, the sampling percentage may affect the time duration of the sampling period. All else being equal, the smaller the sampling percentage, the longer is the sampling period. In some embodiments, the sampling percentage may be defined relative to the variation of the sampled data points. The greater is the variance in the sampled data points, the larger the sampling percentage should be to make the result representative of the entire data population.

The step size attribute refers to the smallest unit the tuning process may use in its operation and calculations. In an operational period, the tuning process may obtain the performance of the parameter being tuned using the current parameter, the current parameter plus the step size (referred to herein as the variable “X”) and the current parameter minus the step size (i.e., current parameter and current parameter +/−X). In some embodiments, the step size may be 1. In general, the step size may be any desired value. The specific value of the step size generally depends on the particular parameter being tuned and may determine how fast the tuning process determines the optimal value for the parameter being tuned. A step size that is too large may prevent the tuning process from converging to a solution.

The sample range attribute may define which data are eligible for sampling and generally in terms of a metric other than that of the parameter being tuned. For example, if the process is used to tune the optimal number of outstanding packets allowed on a logical link, the sample range may be defined in terms of the size of the packets of the transmission. That is, only messages falling within a certain range of sizes may be sampled.

Data that falls within the range might be sampled depending on the sampling percentage and the policy of sampling. For example, a policy may include beginning to collect samples after a predetermined amount of eligible data have been counted, provided that the sampling percentage is not 100%. The predetermined amount of data may be the sample size times one minus the sample percentage and that result divided by the sample percentage, that is:

$$( sample size ) ( \frac{1 - sample percentage}{sample percentage} )$$

Generally, no limitation is placed on the value of the sample range. Without loss of generality, however, a sample range that is too narrow may cause the tuning process to take a longer time to find the optimal value of the parameter being tuned, as there may be fewer data points available from which to choose. As such, a larger sample range is useful to quicken the speed at which the tuning process operates.

The delta attribute generally is defined as the unit increment (or decrement) to a parameter value. As explained above, the step size attribute may be used to delimit the parameter being tuned for sampling purpose. As will be explained below, the tuning process then may determine whether to increase or decrease the value of a parameter according to the performance data obtained. The delta attribute may be used to specify the incremental amount by which the parameter is changed towards an optimal value. In some embodiments, delta may be equal to the step size.

Referring to FIG. 3, a process 60 is shown for dynamically tuning a selected parameter in accordance with some embodiments of the invention. In some embodiments, the process may be implemented as a software library running on each node. In general, the process includes code that can be executed by a processor. In block 62, the system is initialized. The initialization activity may be system-specific, but generally includes a type of initialization activity such as may occur when “booting up” a computer. In block 64, one or more of the attributes discussed above are loaded, or otherwise associated with, the process. The attributes may be entered by a user operating a console or from a database of previously stored attribute values.

In block 66, a “skip counter” is reset to an initial value (e.g., 0). The implementation of this block will depend on the particular parameter being tuned. In block 68, performance data is obtained if and when a client request is presented to and serviced by the system in which the tuning process resides. In decision block 70, the process 60 determines whether the data value obtained in 68 falls within the sample range as defined by the sample range attribute explained previously. If the data value obtained in 68 does not fall within the sample range, indicating invalid data for purposes of the process, control loops back to block 68 in which another data value is obtained. Alternatively, the validity of a client request pertaining to this parameter tuning process might be determined before the corresponding performance data is obtained if resource usage in performance measurement is a significant factor in the environment in which this tuning algorithm is applied. In this case, the performance of client requests is not measured until the tuning process has taken the execution flow starting in block 78. Consequently, if the algorithm has taken any of the ‘No’ flows out of block 70 or block 72, the system in which the turning process resides may process the client request without its performance being measured.

If, however, the data value obtained in block 68 falls within the specified sample range, control passes to decision block 72. In decision block 72, the value of the skip counter is compared to the amount of data that is not to be sampled. As explained previously, not all data need be sampled (although all data can be sampled if desired). The sample percentage attribute indicates the relative amount of data to be sampled during a sampling period. The value of this attribute may be specified as a percentage. Accordingly, one minus the sample percentage indicates the relative amount of data that should be sampled. Further, multiplying the sample size by one minus the sample percentage and dividing that result by the sample percentage may result in a value indicative of the absolute amount of data that should not be sampled for purposes of the tuning process. Thus, in decision block 72, if the value of the skip counter is not greater than the sample size times one minus the sample percentage divided by sample percentage, then not enough data values have been skipped. In this case, control passes to block 74 in which the skip counter is incremented. Another data value is obtained in block 68 and the process continues as described above. Referring still to FIG. 3, if the value of the skip counter is greater than the sample size times one minus the sample percentage divided by sample percentage, then control passes to block 76 in which the sampling period may be started. In block 78, data may be sampled and collected into two or more sets. One set may include samples associated with the parameter value at its current setting. Another set of sample data may include data sampled with the parameter being incremented by the value of the step size. A third set of sample data may include data sampled with the parameter being decremented by the step size. For example, if the parameter is currently set at a value of 8 and may be any integer value between 1 and 10, the three sets of sampled data may include data with the parameter at a value of 7, 8 and 9 (assuming a step sized of 1). In some cases, only two values of the parameter are possible. For example, in the example above in which the parameter may only range between 1 and 10, if the parameter starts out at a value of 1, then only two sample sets are possible—one set associated with a parameter value of 1 and another set for a parameter value of 2.

In at least some embodiments, if the performance lost associated with a decrease in a unit of resource usage and a change in parameter value is not more than the percentage significance, the parameter value associated with a decrease of a unit of resource usage may be honored. By way of example, the following illustrates an embodiment of the tuning process for a percentage significance equal to 5%. In this example, the current parameter is referred to as CURRENT. CURRENT is changed to CURRENT-X when both of the following are true:

a. performance of CURRENT is not 5% or more better than CURRENT−X, and

b. performance of CURRENT+X is not 5%*2=10% or more better than the performance of CURRENT.

CURRENT is changed to CURRENT+X when both of the following are true:

a. performance of Current+X is 5% better than that of Current

b. performance of Current+X is 5%*2 better than that of Current−X

If neither condition is met, the current parameter value remains at the value of CURRENT.

In block 80, the performance associated with each data set is determined and in block 82, the parameter value may be set to the parameter value that resulted in an optimal performance level. After the parameter is tuned in an iteration of the tuning process, the tuning process may immediately repeat itself or permit a time period to expire before proceeding with the next iteration of the tuning process. The time period gap between successive iterations of the tuning process may be defined in terms of an amount of sample data that is permitted to occur. The sample percentage may be used to implement this time gap as described previously.

In accordance with at least some embodiments of the invention, the performance data is the transmission rate of each batch of samples. For example, the parameter being tuned may comprise a number of outstanding packets allowed to a remote connection. In block 78, the process collects the performance data for all three sets of data. It does so by keeping track of the cumulative data sent and cumulative time taken for each batch. More specifically, for each sample, the process timestamps the data structure associated with the transfer before the data is sent and receives a timestamp again after the acknowledgement of such transfer is received. The difference of these two timestamps indicates the time it takes for the transfer to complete. Such time duration is added to the cumulative time taken and the size of the transfer is added to the cumulative data sent. After the data is collected, the process performs block 80 in which the cumulative data sent is divided by cumulative time taken to obtain the transmission rate. These three transmission rates may then be compared when performing block 82.

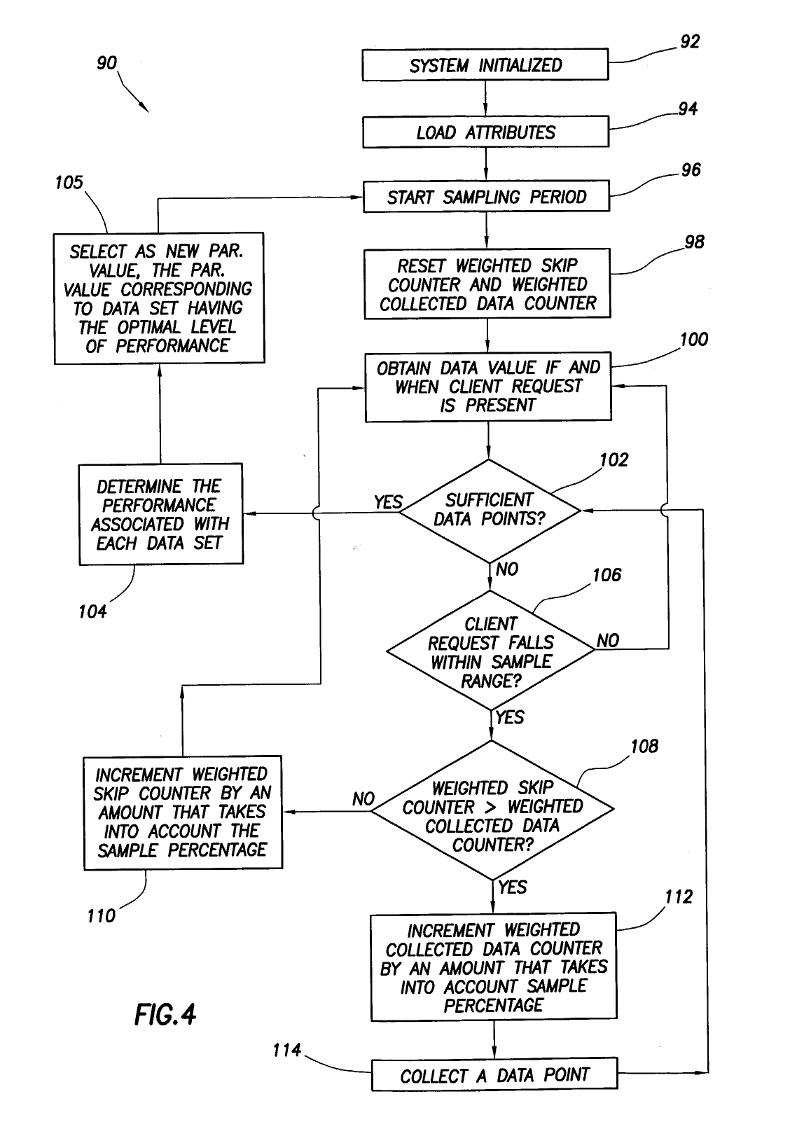

FIG. 4 shows an alternative process 90 for tuning a system parameter. As for process 60 of FIG. 3, process 90 includes initializing the system (block 92) and loading the process attributes (block 94). In block 96 the sampling period is started. In block 98 a weighted skip counter and a weighted collected point counter are reset to an initial value (e.g., 0). In block 100, a performance data value is obtained if and when a client request is presented to and serviced by the system in which the tuning process resides. In decision block 102, the process determines whether a sufficient number of data points have been collected. If so, control passes to block 104 in which, the performance of each of multiple sets of data values is determined and in block 105, the optimal value of the parameter is selected (as described previously).

If an insufficient number of data points has been collected, control passes to decision block 106 in which the process determines whether the client request corresponding to the most recently obtained data value falls within the specified sample range. If the client request does not fall within the specified sample range, control loops back to block 100 and a new data value is obtained. As usual, the client request is still served by the system in which the tuning process resides. If, however, the recently obtained data value does fall within the specified sample range, control continues with decision block 108.

Alternatively, if resource usage in performance measurement is a significant factor in the system in which this tuning algorithm is applied, the validity of a client request pertaining to this parameter tuning process might be determined in block 106 before the corresponding performance data is obtained. In this case, the performance of client requests is not measured in block 100 and not until the algorithm reaches block 114. Consequently, if the algorithm has taken the ‘Yes’ flow out of block 102, the ‘No’ flow out of block 106 or the out flow from block 110, the system in which the turning process resides processes the client request without its performance being measured.

Referring still to FIG. 4, in decision block 108, the value of the weighted skip counter is compared to the value of the weighted collected data counter. If the weighted skip counter is not greater than the weighted collected data counter, control passes to block 110 in which the weighted skip counter is incremented by an amount that takes into account the sample percentage. The incremental amount may be a function of one minus the sample percentage. The incremental amount also may be related to the size of the client request, divided by one minus the sample percentage.

If, however, the weighted skip counter is greater than the weighted collected data counter, control passes to block 112. In block 112, the weighted collected data counter is incremented by an amount that takes into account the sample percentage or by an amount that is equal or approximately equal to the client size request divided by the sample percentage. In general, the incremental amounts used to increment the weighted skip and weighted collected data counters in blocks 110 and 112 permit the counters to be incremented in such a way that takes into account the amount of data that is to be sampled relative to the amount of data is to be skipped.

The increment may be exactly the client request size divided by a percentage. For the weighted skip counter, the percentage may be one minus the sample percentage and for the weighted collected data counter, the percentage may be the sample percentage. The corner cases of which sample percentage is 100% or 0% may need to be handled differently to avoid a possible divide-by-zero problem. If the sample percentage is 100%, there is no need to skip any data, hence block 70 can flow directly into block 76. If the sample percentage is 0%, block 72 can flow directly back into block 66. In block 114, the process collects a data point to be included in at least one of the data sets noted above.

FIGS. 3 and 4 provide processes by which data may be collected from which performance can be determined for setting the parameter. In FIG. 3, process 60 is directed to skipping a plurality of data values and then collecting a subsequent plurality of data values as defined by the sampling percentage. For example, in process 60 with a sampling percentage of 20%, out of 1000 eligible data points, the first 800 data points may be skipped and the remaining 200 data points may be collected. In FIG. 4, process 90 is directed to skipping a plurality of data values, collecting a data value, skipping another plurality of data values, collecting a data value, and so on. Continuing the example above, the first four eligible data points (80%) may be skipped followed by collecting the next data point (20%). This process may repeat itself, repeatedly skipping eight data points and collecting two data points, until 20% of the eligible data points are collected.

As described above, various embodiments of the tuning process include collecting more than one set of data. At least one set may be associated with the current value of the parameter being tuned. One or more other data sets may pertain to the parameter adjusted up and/or down. For example, one of such other data sets may pertain to the parameter incremented by the step size specified above and another data set may pertain to the parameter decremented by the step size specified above. The step size may be any desired value such as 1.

Assuming, for example, that three data sets are to be collected (for the current parameter value and also the current parameter value plus and minus the step size), numerous embodiments are possible for how the three data sets are collected. Consider first process 60 of FIG. 3 (in which the data to be used to tune the parameter) may be collected sequentially after skipping a suitable number of data values). Once the sampling period begins (block 76), of the total number of data values to be collected, the first third of such total may be collected with the parameter value set, for example, to its current value. The next third of the total number of data values to be collected may be collected with the parameter decremented by the step size. The final third of the total number of data values to be collected may be collected with the parameter incremented by the step size. That is, collect data with the parameter set at a value P (the current parameter value) and then collect data with the parameter set to P-X (where X is the step size), followed by collecting data with the parameter set to P+X. The order of the parameter values may be altered as desired. For example, the first third of the total data values to be collected may be collected with a parameter value of P-X, followed by parameter values of P and then P+X.

In accordance with other embodiments, rather than holding the parameter value fixed while collecting all of the data needed for a complete data set, the data may be collected by rotating parameter values between P-X, P, and P+X with each subsequent data value. For example, once the sampling period begins in process 60 of FIG. 3, the first data value may be collected for a parameter value of P-X. The next data value may be collected for a parameter value of P and the third data value may be collected for a parameter value of P+X. For the fourth data value, the parameter may again be set to P-X, and so on.

The same techniques of collecting multiple data sets may be applied to process 90 as well. That is, the first third of the collected data points may be obtained with the parameter set at P. The next third of the collected data points may be set with the parameter set at P-X and the last third of the collected data points may be set with the parameter set at P+X. Alternatively, the parameter value may be rotated through P-X, P and P+X for each data point collected.

In general, the dynamic parameter tuning processes described herein permit one or more system parameters to be tuned using normal run-time data. That is, the parameter need not be tuned using test data. Instead, the data that would be present in the system anyway for its normal operation is used in the dynamic tuning process. This aspect reduces overhead that is normally associated with test data and thus permits the process to operate efficiently.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method of dynamically tuning a parameter associated with a system, comprising:
operating the system with the parameter set at a current value;
determining a performance of the system with the parameter at the current value;
operating the system with the parameter set at a second value;
determining a performance of the system with the parameter at the second value;
comparing the performances; and
changing the parameter to the second value if the performance of the system at the second value is greater than the performance of the system at the current value by a predetermined amount; or
otherwise maintaining the parameter at the current value.

2. The method of claim 1 wherein the second value is greater than the current value and the method further includes determining a performance of the system with the parameter at a third value that is less than the current value.

3. The method of claim 2 wherein changing the parameter includes changing the parameter to the third value if the performance of the system at the third value is greater than the performance of the system at the current value by the predetermined amount.

4. The method of claim 1 further including selecting at least one attribute to be tuned from the group consisting of sample size, performance significance, sampling percentage, step size, sample range, and delta.

5. A method of dynamically tuning a parameter associated with a system, comprising:
determining a first performance of the system with the parameter at the current value;
determining a second performance of the system with the parameter at a second value that is greater than the current value;
determining a third performance of the system with the parameter at a third value that is less than the current value;
determining which of the first, second and third performances is greatest; and
operating the system with the parameter dynamically set to the greatest of the performances.

6. The method of claim 5 wherein operating the system includes keeping the system operating with the parameter set to the current value unless either of the second or third performances is greater than the first performance by more than a threshold amount and, if so, changing the parameter to the second or third value whose performance exceeds said threshold amount.

7. The method of claim 5 wherein the threshold amount is dynamically configurable.

8. The method of claim 1 wherein the parameter is associated with a size of a message buffer.

9. A system, comprising:
processing logic;
memory coupled to said processing logic; and
a configurable parameter associated with the system;
wherein said processing logic is operable to determine a first performance associated with a current value of the parameter, to determine a second performance associated with a second value of the parameter, and to configure the parameter to be the second value if the second performance exceeds the first performance by more than a threshold amount.

10. The system of claim 9 wherein the second value is greater than the current value and the processing logic further determines a third performance associated with a third value of the parameter, said third parameter being less than the current value.

11. The system of claim 10 wherein the processing logic configures the parameter to be the third value if the third performance is greater than the first performance by the threshold amount.

12. The system of claim 9 wherein the processing logic loads at least one attribute selected from the group consisting of sample size, performance significance, sampling percentage, step size, sample range, and delta.

13. A system, comprising:
processing logic;
memory coupled to said processing logic; and
a configurable parameter associated with the system;
wherein said processing logic sequentially collects three groups of data, each group collected with the configurable parameter set to a different value than for the other groups, determines a performance associated with the system for each group of data, and configures the parameter to be the value associated with the group that has the most optimal value.

14. The system of claim 13 wherein the parameter has a current value and the processing logic only configures the parameter to a new value corresponding to more resource usage in the system if the performance of the new value exceeds the performance associated with the current value by a threshold amount.

15. The system of claim 14 wherein the parameter has a current value and the processing logic only configures the parameter to the new value corresponding to less resource usage in the system if the performance of the current value has not exceeded the performance associated with the performance of the new parameter.

16. The system of claim 15 wherein the threshold amount is programmable.

17. A system, comprising:
processing logic; and
a configurable parameter associated with the system;
wherein said processing logic performs an iterative process for dynamically tuning said parameter, with each iteration the processing logic:
determines a first performance of the system with the parameter set at a current value;
determines a second performance of the system with the parameter set at a second value corresponding to more resource usage in the system;
determines a third performance of the system with the parameter set at a third value corresponding to less resource usage in the system;
sets the parameter at the second value if the second performance exceeds the first performance by a non-zero threshold;
otherwise, sets the parameter at the third value if the first performance does not exceed the third performance by a non-zero threshold.

18. The system of claim 17 wherein the non-zero threshold is programmable.

19. The system of claim 17 wherein the processing logic begins a subsequent iteration through the process after time gap following the previous iteration.

20. The system of claim 19 wherein the time gap is programmable.

21. The system of claim 17 wherein the processing logic determines the first through third performances using data available in the system for purposes other than tuning said parameter.

22. A system, comprising:
a configurable parameter associated with the system; and
a means for determining a first performance of the system with the parameter set at a current value, for determining a second performance of the system with the parameter set at a second value corresponding to more resource usage in the system; for determining a third performance of the system with the parameter set at a third value corresponding to less resource usage in the system; and for reconfiguring the parameter to be the second value if the second performance exceeds the first performance by a non-zero threshold; and for reconfiguring the parameter to be the third value if the first performance does not exceed the third performance by a non-zero threshold.

23. The system of claim 22 wherein the non-zero threshold is programmable.

24. A computer readable storage medium storing instructions that when executed by a processor causes the processor to dynamically tune a configurable system parameter, the instructions comprising:
determining a first performance of the system with the parameter set at a current value;
determining a second performance of the system with the parameter set at a second value corresponding to more resource usage in the system;
determining a third performance of the system with the parameter set at a third value corresponding to less resource usage in the system; and
reconfiguring the parameter to be the second value if the second performance exceeds the first performance by a non-zero threshold; otherwise, reconfiguring the parameter to the third value if the first performance does not exceed the third performance by a non-zero threshold.

25. The computer readable storage medium of claim 24 wherein the instructions' acts of determining the first through third performances includes using data available in the system for purposes other than tuning said parameter.

26. The computer readable storage medium of claim 24 wherein the instructions include changing the non-zero threshold to a different value.

27. An electronic device, comprising:
processing logic; and
a configurable parameter associated with the device;
wherein said processing logic performs an iterative process for dynamically tuning said parameter, with each iteration the processing logic:
determines a first performance of the system with the parameter set at a current value;
determines a second performance of the system with the parameter set at a second value corresponding to more resource usage in the system;
determines a third performance of the system with the parameter set at a third value corresponding to less resource usage in the system;
reconfigures the parameter to be the second value if the second performance exceeds the first performance by a non-zero threshold;
otherwise, reconfigures the parameter to be the third value if the first performance does not exceed the second performance by a non-zero threshold;
wherein the iterative process is programmed with a plurality of attributes, said attributes including a sample size which indicates a number of data points used by the iterative process to tune the parameter and a performance significance which defines a threshold that, when exceeded, causes the value of the parameter to be reconfigured.

28. The electronic device of claim 27 further including a plurality of parameters and the iterative process dynamically tunes all of said plurality of parameters.

29. The electronic device claim 27 wherein the attributes also include a sampling percentage which specifies a portion of total available data to be used in the iterative process.

30. The electronic device claim 27 wherein the attributes also include a step size which defines the smallest unit by which the iterative process reconfigures the parameter.
